(19) United States
(12) Patent Application Publication
(10) Pub. No.: US 2009/0226003 A1
(43) Pub. Date: Sep. 10, 2009

(54) TALK SAFELY COMMUNICATION SYSTEM (TSCS)

(76) Inventor: Cranston Christopher Blakey, Ruckersville, VA (US)

Correspondence Address: CRANSTON C. BLAKEY, 1943 SWIFTRUN RD, RUCKERSVILLE, VA, 22968, US

(21) Appl. No.: 12/044,947

(22) Filed: Mar. 8, 2008

(51) Int. Cl. H04B 1/00

(52) U.S. Cl. 381/86

(57) ABSTRACT

The TALK SAFELY COMMUNICATION SYSTEM (TSCS) is a method of providing safe communication from driver to rear passengers in particularly large vehicles; i.e. SUV'S, minivans, etc. TSCS eliminates drivers over-the-shoulder conversation while increasing safety. This said method allows the driver to focus 100% of his/her attention facing forward when communicating with rear passengers. The art of this invention is to create a mental sense of awareness from driver to rear passengers eliminating deaf spots and allowing the driver to concentrate on driving.

The TALK SAFELY COMMUNICATION SYSTEM (TSCS) is a method of providing safe communication from driver to rear passengers. The TSCS is comprised of a control unit, speakers, microphones and a receiver. An on and off volume switch control unit, controls an input/output audio receiver located behind or up under the dash board of the vehicle. The receiver is connected to microphones located in the front frame panels on the passenger and driver side of the vehicle. These said microphones correspond to speakers located in the left and right side rear panels, plus the left and right side third row panels. The receiver is also connected to microphones installed in the left and right side frame panels of the rear and third row passenger seats. These microphones correspond to speakers located in the doors of the driver and side seat passenger. All said speakers are connected to the receiver. These specifications contain no new matter.

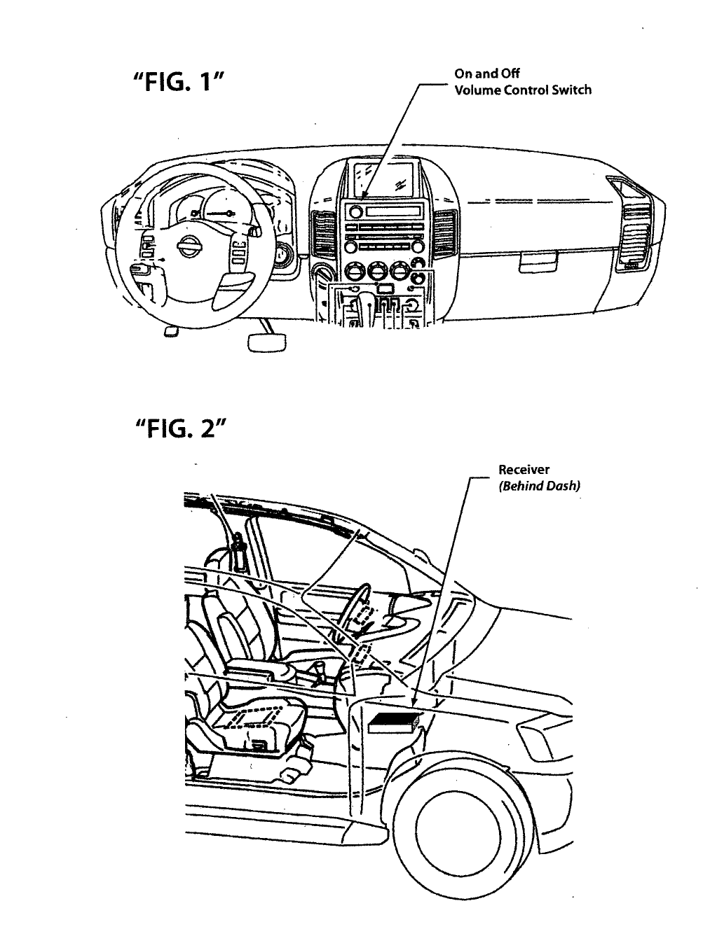

FIG. 1 is a diagram of an on and off control switch installed in the dash board of a vehicle.

FIG. 2 is a diagram of a receiver installed behind the dash board of a vehicle.

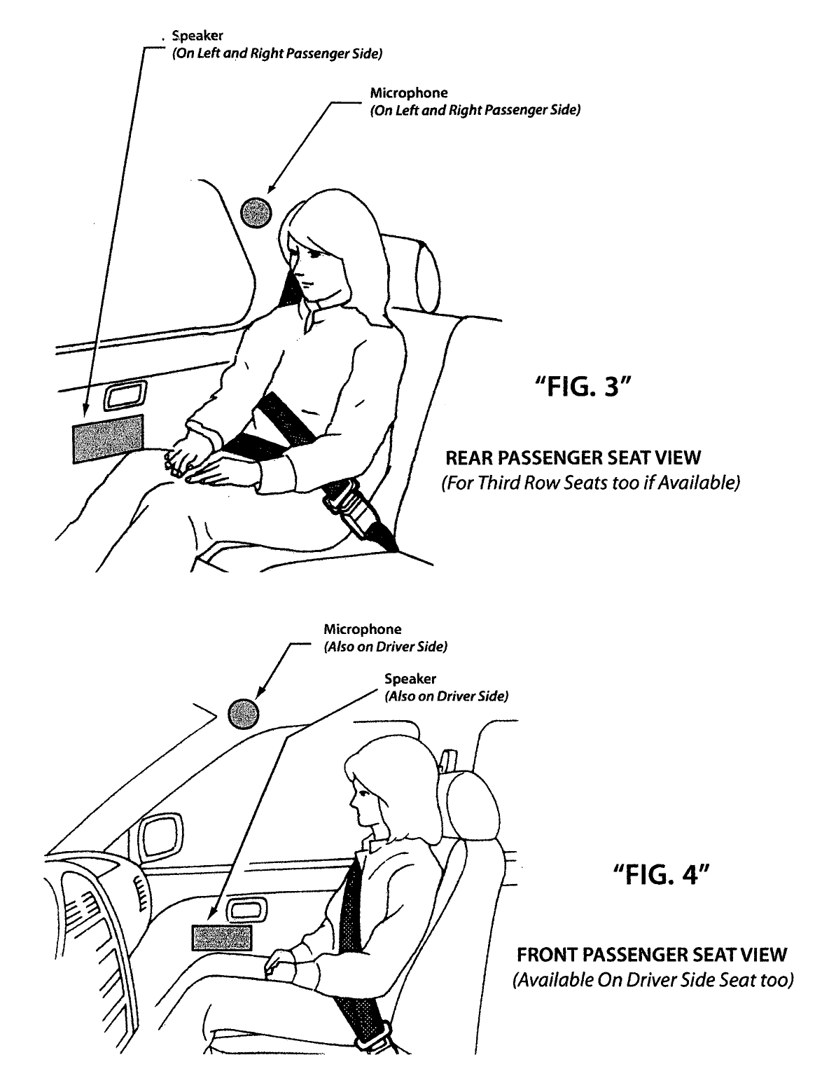

FIG. 3 is a diagram of microphone and speaker positioned for rear and third row passengers of a vehicle.

FIG. 4 is s diagram of microphone and speaker positioned for driver and front seat passenger of a vehicle.

1. A method of safe communication between driver and rear seat passengers while traveling in vehicle. Said method is comprised of: A control unit used to send signals to an audio receiver which connects to speakers, and microphones that work in correlation to transmit and receive voice signals.

2. Input/output audio receiver located behind or up under dash board.

3. Audio receivers connection to microphones located inside front, rear, and third row frame panels of vehicle.

4-8. (canceled)
